(19) United States
(12) Patent Application Publication
(10) Pub. No.: US 2007/0228094 A1
(43) Pub. Date: Oct. 4, 2007

(54) Removable carrying accessory for crutch

(76) Inventor: Paul A. Bednarz, Greensboro, NC (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/397,086

(22) Filed: Apr. 4, 2006

(51) Int. Cl. B60R 7/00; B60R 9/00; B60R 11/00

(52) U.S. Cl. 224/407; 224/563

(57) ABSTRACT

An accessory for carrying personal items which is attachable to and removable from a crutch or other mobility-assistance device, such as a cane, walker or the like. The accessory is configured to be secured only to the vertical members of the device frame, leaving the arm rest and handle unencumbered.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

This invention relates generally to medical accessories and, more particularly, to an accessory for carrying personal items which is removable and re-attachable to a crutch or other mobility-assistance device and which does not interfere with the handles or arm rests of the device.

Persons utilizing mobility-assistance devices such as crutches, canes, walkers and the like often have difficulty carrying personal items such as wallets, keys, mobile telephones, and other items. These persons can carry a backpack for larger items. Backpacks, however, are cumbersome and difficult to gain quick and easy access to while moving around. In addition, backpacks may pose security risks in that they are left exposed on the person's back. Accessory pouches currently in use require disassembly of the crutch or device in order to attach or adjust the pouch, are not secure or are attached to the handle or arm rest of the device—interfering with the comfort of the device, and/or requiring the use of bolts or other hardware to attach to the device.

### BRIEF SUMMARY OF THE INVENTION

The present invention provides an accessory for carrying personal items, wherein the accessory is removably attachable to a crutch, cane, walker or other mobility-assistance device. The accessory is adapted for attachment to a mobility-assistance device without attachment to the handle or armrest of the device, preferably at a vertical height below the handle. The accessory has a compartment defining a cavity within and having an opening. The accessory also has a first and a second set of side flaps extending from the compartment, each set comprising an exterior side flap and an interior side flap. Each set of exterior and interior side flaps is designed to removably attach to the vertical side frame pieces of the device. Preferably the first and second side flaps of each set attach to each other to surround a vertical side frame pieces of the device. Alternatively, or in combination, the interior surface of one or both of the first and second side flaps of each set attaches directly to the exterior of a side frame piece of the device. Preferably, the accessory also has a flap, panel or other cover for closing the cavity.

### BRIEF DESCRIPTION OF THE DRAWINGS

FIG. 1 is a front perspective view of a first embodiment of the accessory of the present invention, showing attachment to a standard crutch;

FIG. 2 is a front view of the first embodiment of the accessory of the present invention, showing attachment to a standard crutch;

FIG. 3 is a rear view of the first embodiment of the accessory of the present invention, showing attachment to a standard crutch;

FIG. 4 is a top cut-away view of the first embodiment of the accessory of the present invention attached to a standard crutch;

FIG. 5 is a rear perspective view of the first embodiment of the accessory of the present invention, separate from any attachment to a mobility-assistance device.

FIG. 6 is a front perspective view of an alternative embodiment of the present invention, separate from any attachment to a mobility-assistance device;

FIG. 7 is a front perspective view of a standard crutch adapted for use in an alternative embodiment of the present invention.

### DETAILED DESCRIPTION OF PREFERRED EMBODIMENT

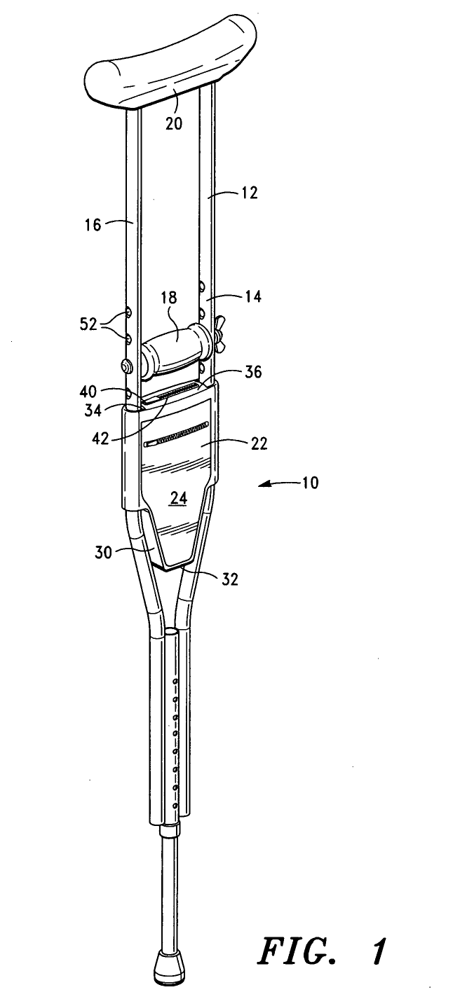

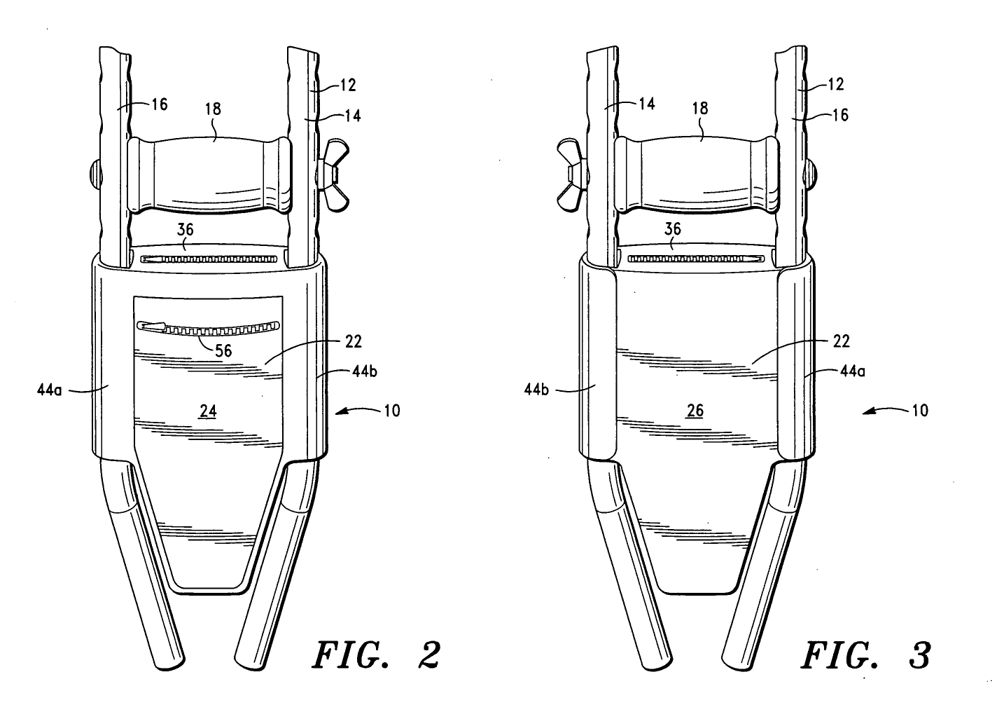

Referring initially to FIGS. 1-3, in a preferred embodiment of the invention, accessory 10 is removably attached to standard crutch 12, generally comprised of first vertical side frame piece 14, second vertical side frame piece 16, horizontal handle 18, and horizontal arm rest 20. As best shown in FIGS. 1 and 4, accessory 10 comprises compartment 22 having front wall 24, rear wall 26, first vertical side wall 28, second vertical side wall 30, and bottom wall 32 defining a cavity within. The walls of compartment 22 further define opening 34 and, in the preferred embodiment, compartment 22 further comprises panel 36 covering opening 34. Panel 36 defines aperture 40 through which access to the cavity within compartment 22 is made and which is closable for security purposes. Aperture 40 is preferably closable with zipper 42, but could also be closed by way of snaps, ties, toggles, hook and loop material or other closing devices known in the art.

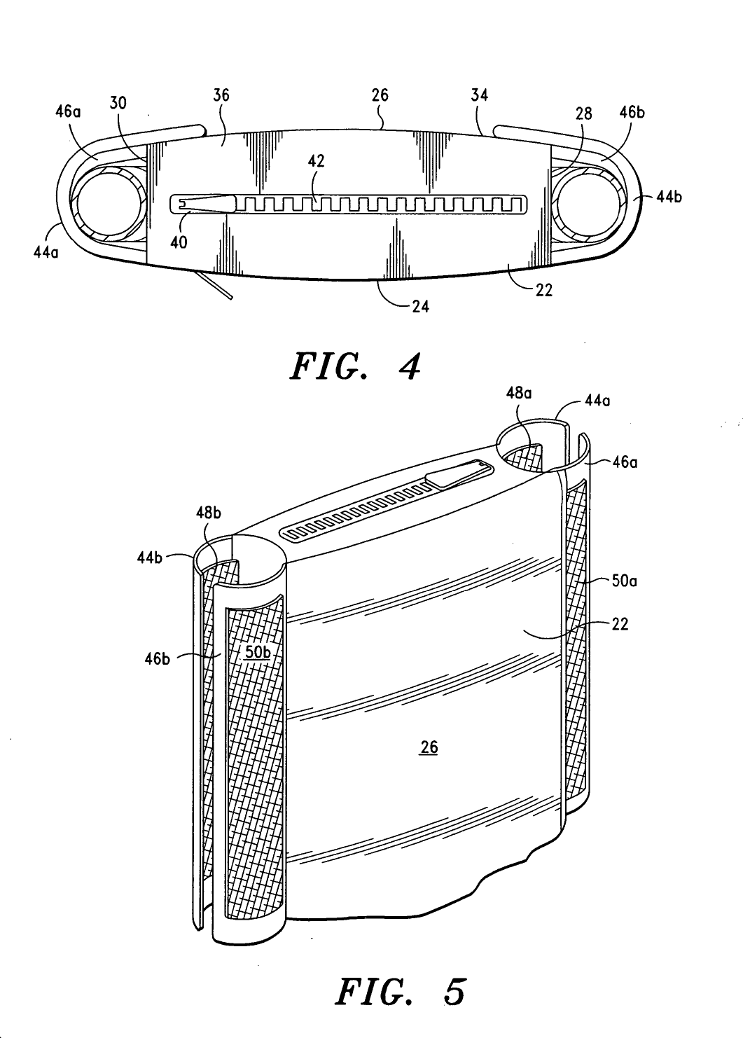

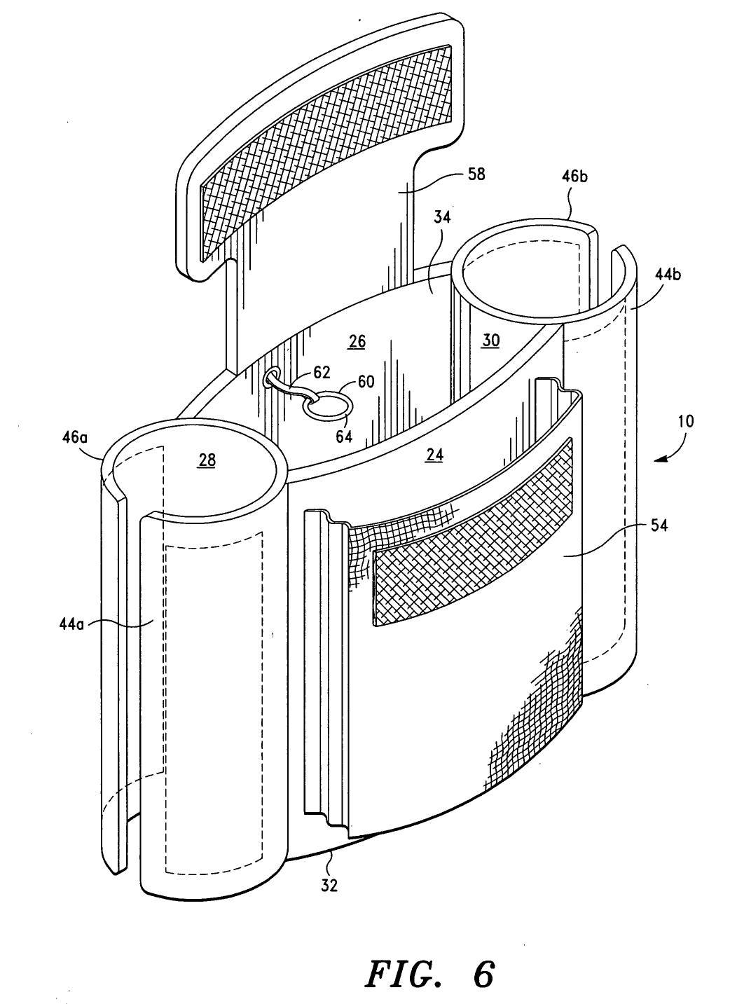

Turning to FIGS. 4 and 5, a set of side flaps 44 and 46 extend outward from each side wall of compartment 22. Each set of side flaps comprises exterior side flap 44 and interior side flap 46. As shown in FIG. 4, exterior side flaps 44a and b and interior side flaps 46a and b securely surround vertical side frame pieces 14 and 16, respectively, to secure accessory 10 to crutch 12. As best seen in FIGS. 3 and 4, in the preferred embodiment, exterior side flaps 44a and b overlap and attach to interior side flaps 46a and b to form loops that surround vertical side frame pieces 14 and 16. As shown in FIG. 5, in the preferred embodiment, securing strips 48a and b of one side of a hook and loop material are attached to the interior surface of each exterior side flaps 44a and b, and securing strips 50a and b of the corresponding side of the hook and loop material are attached to the exterior surface of each interior side flaps 46a and b. Securing strips 48a and b are received onto securing strips 50a and b. Alternatively, exterior side flaps 44a and b may be removably attached to interior side flaps 46a and b by way of snaps, ties, toggles, zippers or other attachment devices known in the art.

Side flaps 44a and b and 46a and b preferably extend the entire height of compartment 30. It is within the scope of the present invention, however, for side flaps 44a and b and 46a and b to be shorter in length than height of compartment 22, provided side flaps 44a and b and 46a and b are sufficient in length to adequately and securely support accessory 10 on crutch 12. Side flaps 44a and b and 46a and b may be separate panels or may be extensions of side walls 28 and 30. Securing strips 48a and b and 50a and b are preferably the length of side flaps 44a and b and 46a and b. It is within the scope of the present invention, however, for securing strips 48a and b and 50a and b to be shorter in length or to comprise multiple bands of hook and loop material (not shown) spaced along side flaps 44a and b and 46a and b, as long as a sufficient securing surface is present. Securing strips 48a and b and 50a and b are preferably stitched to side flaps 44a and b and 46a and b, but adhesive or other fastening known in the art could also be used.

Returning to FIG. 1, accessory 10 is configured to attach to side frame pieces 14 and 16 at a vertical position below horizontal handle 18 and below horizontal arm rest 20 so as to not interfere with use of the crutch. Accessory 10 is not connected horizontal handle 18, horizontal arm rest 20 or any other horizontal frame pieces, and there is preferably a vertical space between the top edge of accessory 10 and the bottom edge of horizontal handle 18. Accessory 10 is spaced below the apertures 52 for adjusting horizontal handle 18 such that crutch 12 remains fully adjustable even when accessory 10 is attached. Accessory 10 is primarily housed between vertical frame pieces 14 and 16 such that it has a shallow profile and does not interfere with use of the crutch.

Compartment 22 is generally shaped to conform to the interior framework shape of a standard crutch 12. Compartment 22 may be any shape, such as trapezoidal, rectangular, triangular, round or other shapes commonly used for totes or pouches. Front wall 24, rear wall 26, first vertical side wall 28, second vertical side wall 30, and bottom wall 32 may be individual panels of material which are connected to each other to form compartment 22 or may be a single piece of material formed into the shape of compartment 22. Furthermore, bottom wall 40 may be a separate panel, or may be an extension of side walls 28 and 30, and in the case of a circle, side walls 28 and 30 and bottom wall 32 are combined into a continuous wall. Any separate pieces forming compartment 22 are preferably stitched together. It is within the scope of the present invention, however, for such pieces to be connected with the use of adhesive, rivets or other connective means commonly used in securing pieces of material together.

As shown in FIG. 1, in a preferred embodiment, accessory 22 has exterior pocket 54 for accommodating additional personal items. In the preferred embodiment, exterior pocket 54 comprises a separate piece of material and is secured to compartment 22 on the exterior of front wall 24. As shown in FIG. 1, exterior pocket 54 is closable by zipper 56. Of course, as discussed above, alternative closing devices include snaps, ties, toggles or other closing devices known in the art.

Accessory 10 is preferably made of a combination of durable nylon and neoprene. For example, compartment 22 is preferably neoprene which provides an expandable compartment for receiving and accommodating various sizes and shapes of personal items. Interior side flaps 46a and b are also preferably made of neoprene. Exterior pocket 54, if present, and exterior side flaps 44a and b are preferably made of nylon. It is within the scope of the present invention, however, for accessory 10 to be made entirely of nylon or entirely of neoprene or for the materials to be used in any combination. In addition, other durable materials such as canvas, denim, leather or other materials commonly used for the construction of totes or pouches may be used.

FIG. 6 depicts an alternative embodiment of the present invention. In the alternative embodiment shown in FIG. 6, opening 34 is covered by flap 58. Flap 58 is secured to rear wall 26, preferably by stitching, and is removably attachable to front wall 24, preferably by a hook and loop material. It is also within the scope of the present invention for flap 58 to be secured to front wall 24 and attachable to rear wall 26 or secured to one of the sides walls and attachable to the opposite side wall. Similarly, flap 58 may merely attach to one wall and may not attach to any other wall. Flap 58 may alternatively attach to compartment 22 by snaps, ties, toggles or other closing devices known in the art. Furthermore, flap 58 may be an extension of one of the walls of compartment 22.

In the alternative embodiment shown in FIG. 6, exterior pocket 54 is pleated at the bottom and sides of pocket 54 and is closable via flap 58. It is also within the scope of the present invention for accessory 10 to have no pockets or to have additional pockets (not shown) located on the rear wall 26 or either side wall 28 and 30. It is also within the scope of the present invention to have pockets located on the interior of compartment 22.

As shown in FIG. 6, accessory 10 may also comprise key fob 60. Key fob 60 may be removably attached to accessory 10 and may be located on either the interior or exterior (not shown) of compartment 22. Key fob 60 may also be located at virtually any location on accessory 10. Key fob 60 preferably comprises a strap 62 made of nylon or cord and a key ring 64 comprising hardware commonly used with key chains and the like.

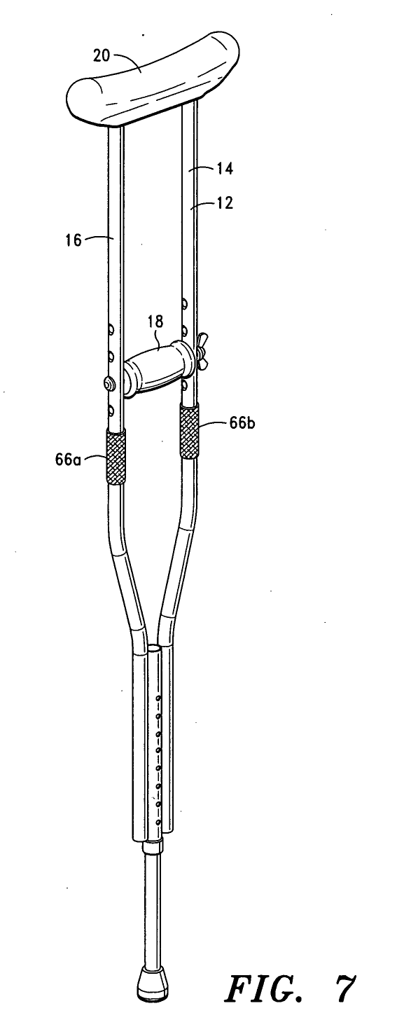

As shown in FIG. 7, in an alternative embodiment, accessory securing strips of hook and loop material 66a and b are attached to the exterior of vertical side frames 14 and 16 at the vertical location where accessory 10 will be attached. The accessory securing strips 66a and b are preferably attached to side frames 14 and 16 with adhesive. Accessory securing strips 66a and b are preferably the hook portion of the hook and loop material. In such instance, interior side flaps 46a and b are preferably made of neoprene such that the “wrong” side of the neoprene material, which forms the interior side of interior side flaps 46a and b act as the loop portion of the hook and loop material. The interior surfaces of side flaps 46a and b thus serve as frame securing surfaces and connect to accessory securing strips 66a and b to secure accessory 10 to crutch 12. In the alternative, separate pieces of hook and loop material (not shown) may be secured to the interior surfaces of interior side flaps 46a and b to act as a frame securing surface attachable to accessory securing strips 66a and b. In such instance, interior side flaps 46a and b may be made of virtually any material. Alternatively, adhesive or other fastening material may be affixed to the exterior of frame pieces 14 and 16 and/or the interior of interior side flaps 46a and b to serve as accessory securing surfaces and frame securing surfaces, respectively.

Accessory securing strips 66a and b preferably extend at least ½ way around vertical side frame pieces 14 and 16. It is within the scope of the present invention, however, for accessory securing strips 66a and b to extend entirely around vertical side frame pieces 14 and 16 or to cover less than ½ of vertical side frame pieces 14 and 16. Accessory securing strips 66a and b also preferably extend the entire height of interior side flaps 46a and b. It is within the scope of the present invention, however, for accessory securing strips 66a and b to be shorter in length or to comprise multiple bands of hook and loop material (not shown) spaced along the vertical side frame pieces 14 and 16, as long as a sufficient securing force is present.

In additional alternative embodiments (not shown) accessory 10 may have more than one compartment 22. Additionally, compartment 22 may extend beyond frame of crutch 12 if necessary to accommodate larger items. It is also within the scope of the present invention for accessory 10 to be attached to a walker at either the front or side of the walker. In either case, the accessory 10 is attached to the vertical frame pieces of the walker to avoid interference with handles and with use of the walker.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and sub-combinations are of utility and may be employed without reference to other features and sub-combinations. It should be understood that the various features described with respect to the alternative embodiments may be combined with the various features described with respect to the preferred embodiment, such that any combination of the features described herein is contemplated by the present invention. This is contemplated by and is within the scope of the claims.

What is claimed and desired to be secured by Letters Patent is as follows:

1. An accessory for carrying items, the accessory being configured to removably attach to a mobility-assistance device, said accessory comprising:
a compartment comprising a front wall, a rear wall, a first side wall, a second side wall and a bottom wall defining a cavity within and having an opening;
a first set of side flaps extending from said compartment comprising a first exterior side flap and a first interior side flap, said first exterior side flap designed to removably attach to said first interior side flap to form a first loop for surrounding a first vertical side frame piece of the device; and
a second set of side flaps extending from said compartment comprising a second exterior side flap and a second interior side flap, said second exterior side flap designed to removably attach to said second interior side flap to form a second loop for surrounding a second vertical side frame piece of the device;
wherein said first and second loops allow said accessory to removably attach to the device without attachment to horizontal members of the device.

2. The accessory of claim 1, wherein said compartment is configured to fit between the first and second vertical side frame pieces of the device.

3. The accessory of claim 2, wherein said compartment is configured to fit between the first and second vertical side frame pieces of a standard crutch.

4. The accessory of claim 1, wherein said first exterior side flap is removably attached to said first interior side flap by a hook and loop material and wherein said second exterior side flap is removably attached to said second interior side flap by a hook and loop material.

5. The accessory of claim 1 further comprising a first frame securing surface located on the interior surface of said first interior side flap and a second frame securing surface located on the interior surface of said second interior side flap.

6. The accessory of claim 5, wherein said first and second frame securing surfaces comprise a hook and loop material.

7. The accessory of claim 1, further comprising a cover for said opening.

8. The accessory of claim 7, wherein said cover is a panel connected to the upper edges of said compartment rear wall, said compartment front wall, and said compartment first and second side walls, and having an aperture therein.

9. The accessory of claim 8, wherein said panel comprises a closure for said aperture.

10. The accessory of claim 9, wherein said closure is a zipper.

11. The accessory of claim 7, wherein said cover is a flap connected to said rear wall of said compartment and removably attachable to the front wall of said compartment.

12. The accessory of claim 1, further comprising a means for closing said opening.

13. The accessory of claim 1, wherein said accessory is made at least partly of nylon material.

14. The accessory of claim 1, wherein said accessory is made at least partly of neoprene material.

15. A mobility-assistance device having an accessory for carrying items, comprising:
a mobility-assistance device, comprising:
(a) a first vertical side frame piece;
(b) a second vertical side frame piece; and
(c) at least one horizontal frame piece connecting said first vertical side frame piece and said second vertical side frame piece; and
an accessory for carrying items;
wherein said accessory is removably attached to said first and second vertical frame pieces and not attached to any of said horizontal pieces.

16. The device of claim 15, wherein said accessory comprises:
a compartment defining a cavity within and having an opening;
a first set of side flaps extending from said compartment comprising a first exterior side flap and a first interior side flap, wherein said first set of side flaps are configured to attach to said first vertical side frame piece; and
a second set of side flaps extending from said compartment comprising a second exterior side flap and a second interior side flap, wherein said second set of side flaps are configured to attach to said second vertical side frame piece.

17. The device of claim 16, wherein said accessory is located at a vertical height at the approximate vertical mid-point of said device.

18. The device of claim 16, wherein said device is a standard crutch.

19. The device of claim 16, wherein said device is a standard walker.

20. The device of claim 16, wherein said compartment is configured to fit between the first and second vertical side frame pieces of said device.

21. The device of claim 16, wherein said first exterior side flap is designed to removably attach to said first interior side flap to surround said first vertical side frame piece and said second exterior side flap is designed to removably attach to said second interior side flap to surround said second vertical side frame piece.

22. The device of claim 16, further comprising a first accessory securing surface located on the exterior of said first vertical side frame piece, and a second accessory securing surface located on the exterior of said second vertical side frame piece.

23. The device of claim 22, further comprising a first frame securing surface located on the interior side of said first interior side flap, and a second frame securing surface located on the interior side of said second interior side flap.

24. The device of claim 23, wherein said first and second frame securing surfaces and said first and second accessory securing surfaces are hook and loop type material.
